(19) United States
(12) Patent Application Publication
(10) Pub. No.: US 2009/0083331 A1
(43) Pub. Date: Mar. 26, 2009

(54) METHOD AND APPARATUS FOR CREATING CONTENT FOR PLAYING CONTENTS IN PORTABLE TERMINAL

(75) Inventors: Sung Jo OH, Suwon-si (KR); Manmohan SINGHBISHT, Suwon-si (KR)

Correspondence Address: Jefferson IP Law, LLP, 1730 M Street, NW, Suite 807, Washington, DC, 20036, US

(73) Assignee: SAMSUNG ELECTRONICS CO. LTD., Suwon-si, (KR)

(21) Appl. No.: 12/233,834

(22) Filed: Sep. 19, 2008

(30) Foreign Application Priority Data
Sep. 21, 2007 (KR) 2007-0096618

(51) Int. Cl. G06F 17/00

(52) U.S. Cl. 707/104.1; 707/E17.009

(57) ABSTRACT

Disclosed are a method and an apparatus for creating content for continuously playing a plurality of contents in a portable terminal. The method includes receiving rules in a content setting mode, creating one or more contents according to the received rules, and continuously playing the one or more contents when an input for instructing play of created content is made.

### PRIORITY

This application claims the benefit under 35 U.S.C. §119(a) of a Korean patent application filed in the Korean Intellectual Property Office on Sep. 21, 2007 and assigned Serial No. 2007-0096618, the entire disclosure of which is hereby incorporated by reference.

### BACKGROUND OF THE INVENTION

1. Field of the Invention

The present invention relates to a method and an apparatus for controlling a terminal. More specifically, the present invention relates to a method and an apparatus for creating content for continuously playing a plurality of contents in a portable terminal.

2. Description of the Related Art

Due to developments in portable terminal technologies, mobile communication devices are now able to provide a large number and various types of services. However, all users do not utilize the services or functions in the same way. In other words, frequently used services or functions provided by portable devices may be selected by some users and not by others according to their tastes. Therefore, in addition to the development of the services and functions, there have been numerous attempts to provide these services and functions in a manner that allows users to conveniently select them according to their tastes.

The term “content” refers to all types of information that is obtained by creating, processing, and distributing letters, symbols, voices, sounds, or images in a digital manner so as to be used in a wired or wireless communication network. With advances in technologies, the types of content are becoming diversified and their quantities can be enormous. However, there is an inconvenience associated with such various and vast contents in that users must search for and select their desired content lists one by one in order to use the contents. Further, there is a need for users to perform an input operation in order to recognize at least one content, which further deteriorates the convenience for users.

For example, when the user wants to view a plurality of messages that have been received by a portable terminal, the user selects a message related function for recognizing the messages, and then selects an item of ‘received messages’ to confirm a list of ‘received messages’. The user may then select desired messages from the list of received messages and confirm the selected messages. If the amount of messages exceeds the screen size of a display unit, it is necessary to receive a plurality of inputs from the user in order to execute desired contents, for example, by performing an input operation for moving the screen to the next screen by the user.

Therefore, a need exists for a method for improving convenience for the user, for example, by enabling a configured content to be executed according to the taste of the user without receiving inputs from the user one by one.

### SUMMARY OF THE INVENTION

An aspect of the present invention is to address at least the above-mentioned problems and/or disadvantages and to provide at least the advantages described below. Accordingly, an aspect of the present invention is to provide a method and an apparatus for creating content for freely playing a plurality of desired contents conveniently in a portable terminal.

In accordance with an aspect of the present invention, a method is provided. The method includes receiving rules in a content setting mode, creating one or more contents according to the received rules and continuously playing the one or more contents when an input for instructing play of the created content is made.

In accordance with another aspect of the present invention, an apparatus is provided. The apparatus includes an input unit for receiving an input for setting or playing of one or more contents and a control unit for creating the one or more contents according to the input received by the input unit, and for controlling continuous play of the one or more contents when an instruction for play of the created one or more contents is provided.

In one implementation, the control unit may include a composer for creating a program language based on rules input from a user in a content setting mode and a driver for continuously playing the plurality of contents when an instruction of play of the one or more contents is provided.

In an exemplary implementation, the driver may have an interpreter for interpreting the created program language.

The above-mentioned characteristics and technical advantages of exemplary embodiments of the present invention have been widely and briefly described so that any person skilled in the art can easily understand the present invention from the following description. Therefore, additional characteristics and technical advantages of the present invention that assist in defining features of claims will be easily understood from the following descriptions of exemplary embodiments of the present invention.

Exemplary embodiments of the present invention enable the user to create desired contents in a single content file to thereby continuously play the created contents with no separate input from the user.

Also, exemplary embodiments of the present invention enable the creation of user customized contents desired by the user as well as contents determined and restricted by terminal manufacturers and service providers.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features and advantages of certain exemplary embodiments of the present invention will be more apparent from the following description taken in conjunction with the accompanying drawings, in which:

FIG. 1 is a block diagram illustrating elements of a portable terminal according to an exemplary embodiment of the present invention;

FIG. 2 is a flowchart illustrating a procedure of setting a smart channel according to an exemplary embodiment of the present invention;

FIGS. 3A to 3C are diagrams illustrating a procedure of setting a smart channel according to an exemplary embodiment of the present invention;

FIG. 4 is a flowchart illustrating a procedure of driving a smart channel according to an exemplary embodiment of the present invention;

FIG. 5 is a diagram illustrating a procedure of driving a smart channel according to an exemplary embodiment of the present invention;

FIGS. 6A and 6B are flowcharts illustrating a procedure of setting and driving a smart channel according to an exemplary embodiment of the present invention; and

FIGS. 7A and 7B are flowcharts illustrating a procedure of setting and driving a smart channel according to an exemplary embodiment of the present invention.

Throughout the drawings, it should be noted that like reference numbers are used to depict the same or similar elements, features and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

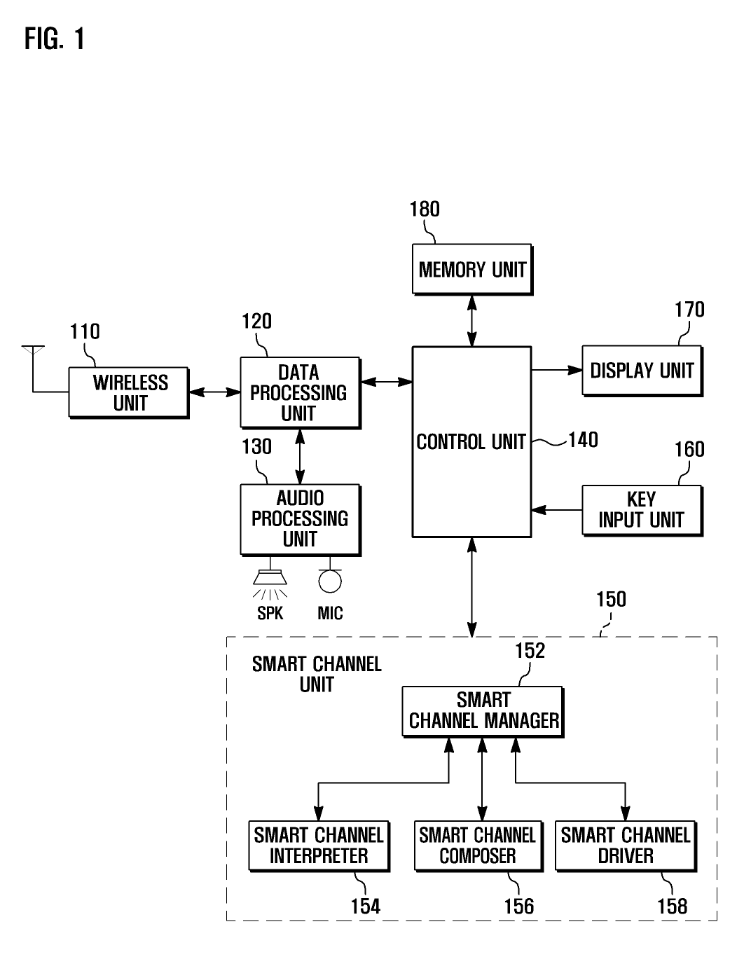

FIG. 1 is a block diagram illustrating elements of a portable terminal according to an exemplary embodiment of the present invention. While the present invention is described below with reference to a portable terminal, it is to be understood that this is merely as an example and should not be construed as limiting the application of the present invention.

Referring to FIG. 1, a wireless unit 110 performs Radio Frequency (RF) communication of the portable terminal. The wireless unit 110 includes a wireless transmitter for up-converting the frequency of a transmitted signal and for amplifying the signal and a wireless receiver for low-noise amplifying a received signal and for down-converting the frequency of the amplified signal. A data processing unit 120 includes a transmitter for encoding and modulating a transmitted signal and a receiver for demodulating and decoding a received signal. That is, the data processing unit 120 includes a modulator/demodulator (MODEM) and a coder/decoder (CODEC). The CODEC may include a data CODEC for processing packet data and an audio CODEC for processing audio signals such as voices. The audio processing unit 130 plays back received audio signals output from the audio CODEC of the data processing unit 120 through a speaker (SPK) or transmits audio signals generated by a microphone (MIC) to the audio CODEC of the data processing unit 120. In an exemplary implementation, the audio processing unit 130 receives a signal input from the user through a microphone to set a smart channel or perform a function. In this case, the term “smart channel” denotes a series of operations for automatically and continuously displaying or playing a plurality of set contents with no separate input of the user, like the concept of a television channel.

A control unit 140 controls the overall operation of the portable terminal. In particular, the control unit 140 controls the operations for setting, interpreting, and driving the smart channel that automatically displays contents. A smart channel unit 150 may include a smart channel manager 152, a smart channel interpreter 154, a smart channel composer 156, and a smart channel driver 158. The smart channel manager 152 manages the overall operations for setting and driving the smart channel. The smart channel interpreter 154 interprets a program language for driving the set smart channel. In an exemplary embodiment of the present invention, an eXtensible Markup Language (XML) or a Synchronized Multimedia Integration Language (SMIL) may be used as the program language. The XML and the SMIL may be set or changed by the user's input suited to the user's taste. The smart channel composer 156 changes a content of a program language file according to the user's input to set or change the smart channel. The channel driver 158 displays or plays contents using the set smart channel. The smart channel unit 150 may be integrated into the controller 140 or may be provided as a separate unit as illustrated in FIG. 1.

A key input unit 160 includes keys for inputting number and text information, and function keys for setting various functions. The user performs an input operation using the key input unit 160. In an exemplary implementation, the key input unit 160 receives input for the setting or playing of contents from the user. A display unit 170 displays various menus, applications, and contents that are related to operations of the portable terminal, and displays various data output from the control unit 140. A Liquid Crystal Display (LCD) window may be used as the display unit 170, in which case, the display unit 170 may include an LCD controller, a memory storing display data, and LCD elements. In this case, if the LCD window is realized in a touch screen, it may act as an input unit for providing the user's input.

A memory unit 180 may include a program memory and data memories. The program memory may store programs for controlling the operation of the portable terminal. The data memories temporarily store data generated during execution of the programs or store externally input data. Further, the data memories may store a program file created to drive the smart channel.

Hereinafter, smart channel setting and driving procedures according to an exemplary embodiment of the present invention will be described in more detail.

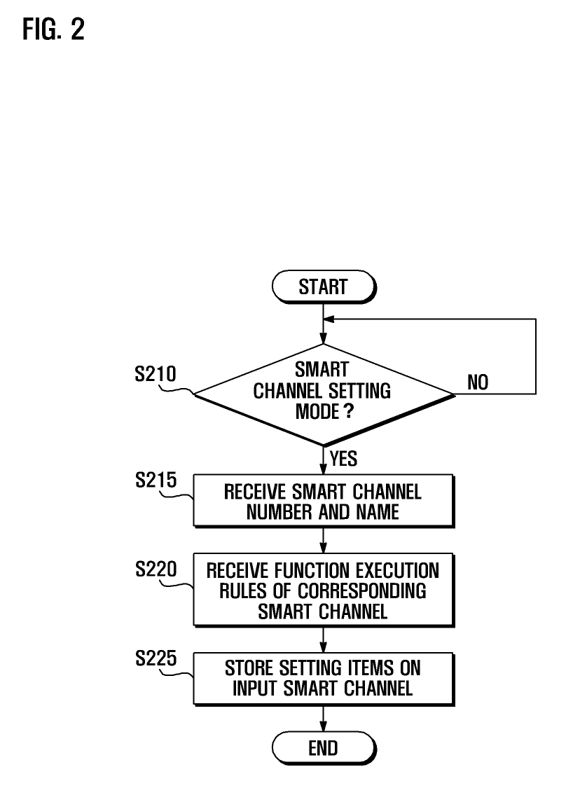

FIG. 2 is a flowchart illustrating a procedure of setting a smart channel according to an exemplary embodiment of the present invention.

Referring to FIG. 2, the smart channel composer 156 of the control unit 140 illustrated in FIG. 1 determines whether the portable terminal is in a smart channel setting mode in step S210. When it is determined that the portable terminal is in the smart channel setting mode, the smart channel composer 156 of the control unit 140 receives a smart channel number and a smart channel name, for setting of the smart channel, from the user in step S215. In an exemplary implementation, the user's input may be a key input through the key input unit 160, an input through the display unit 170 having a touch screen, or a voice input through a microphone. Regarding the setting of the smart channel, for this example it is assumed that ‘1’ and ‘View received messages’ are input as the smart channel number and the smart channel name. In step S220, the smart channel composer 156 of the control unit 140 receives execution rules of functions that are to be associated with the smart channel from the user. There may be rules associated with a sender such as ‘Show only messages received from a specific sender’ or ‘Show only messages received from senders other than a specific sender’ or otherwise rules regarding an execution such as ‘Show all received messages’, ‘Show only unidentified messages’, ‘Show the remaining messages after deletion of spam messages’ and the like. Further, there may be a rule about time that shows one message or a rule about time such as ‘Show messages received for a specific time’.

Upon completion of input of the rules associated with the smart channel that are to be executed according to the user's preference, the smart channel composer 156 of the control unit 140 stores setting items for the input smart channel in step S225. The completion of the storage may be determined through an input from the user, for example, an input through the OK key. Otherwise, when there is no input for a preset time period, the control unit 140 may display a message for the confirmation of the completion on the display unit 170. The setting of the smart channel No. 1 is completed through such a procedure.

The smart channel set through the forgoing procedure may be converted into a smart channel markup language to be stored. Upon reception of a demand for driving of the smart channel, the smart channel driver 158 drives the smart channel as set through interpretation of the stored smart channel markup language by the smart channel interpreter 154.

Table 1 shows an example of setting a smart channel written using an XML as the smart channel markup language.

TABLE 1

```
<scil>
    <head>
        <layout>
            <data>
                <message/>
            </data>
        </layout>
    </head>
<body>
    <interaction mode>
        <view/>
    </interaction mode>
<flexible interaction>
    <user input>
        <channel name = “View All Received Message”
        channel number = “2”/>
    </user input>
    <event>
        <auto>
            <start/>
            <pause/>
            <resume/>
            <end/>
        </auto>
    </event>
    <action>
        <data>
            <message>
                <criteria>
                    <received/>
                </criteria>
                <operation>
                    <all/>
                </operation>
            </message>
        </data>
    </action>
</flexible interaction>
<sharing interaction>
    <sms/>
<sharing interaction>
</body>
</scil>
```

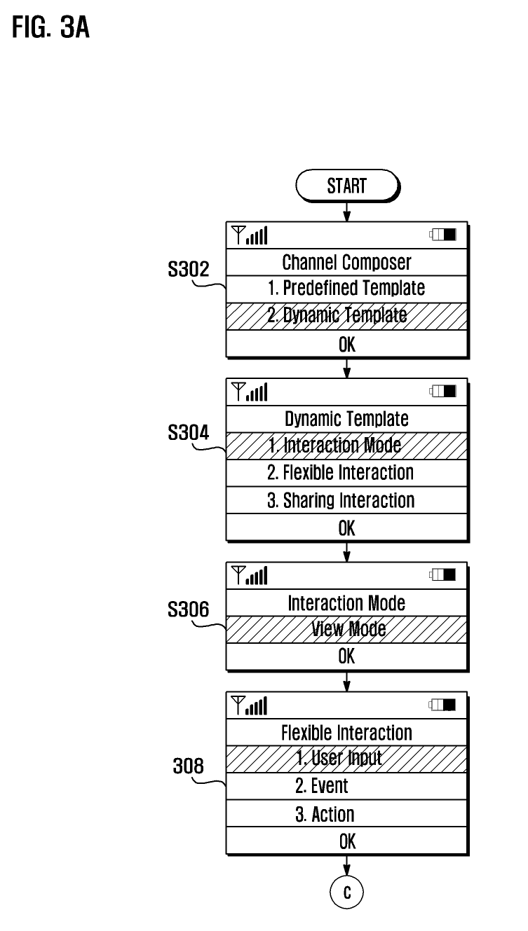

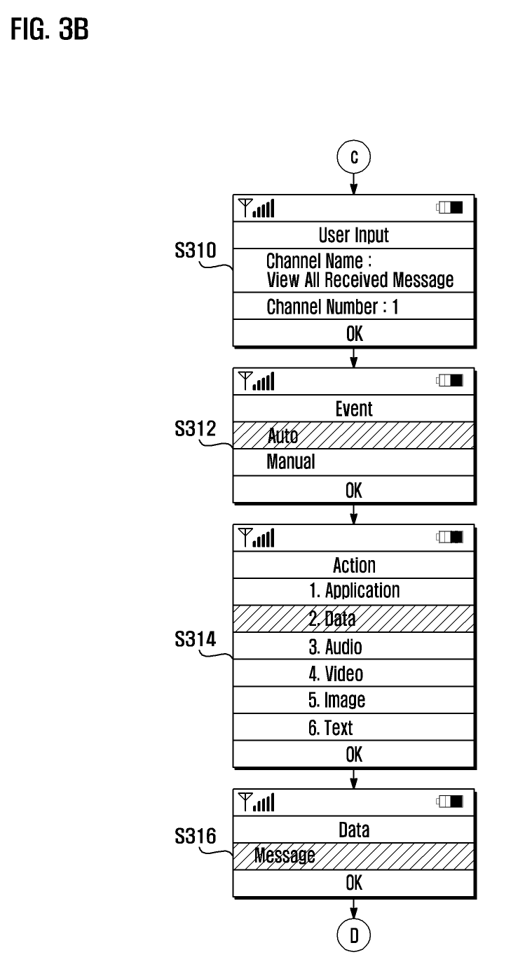

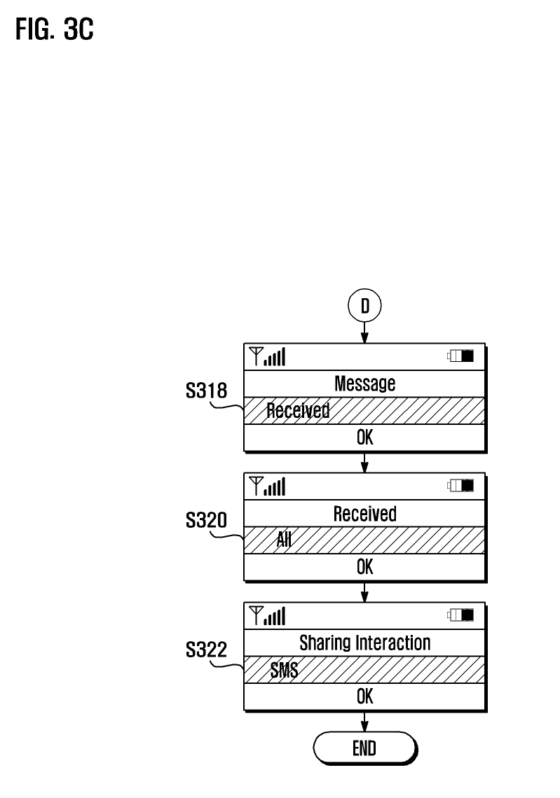

The setting of Table 1 is an example of a program language of a program file written by a setting procedure of FIGS. 3A to 3C.

FIGS. 3A to 3C are diagrams illustrating a procedure of setting a smart channel according to an exemplary embodiment of the present invention.

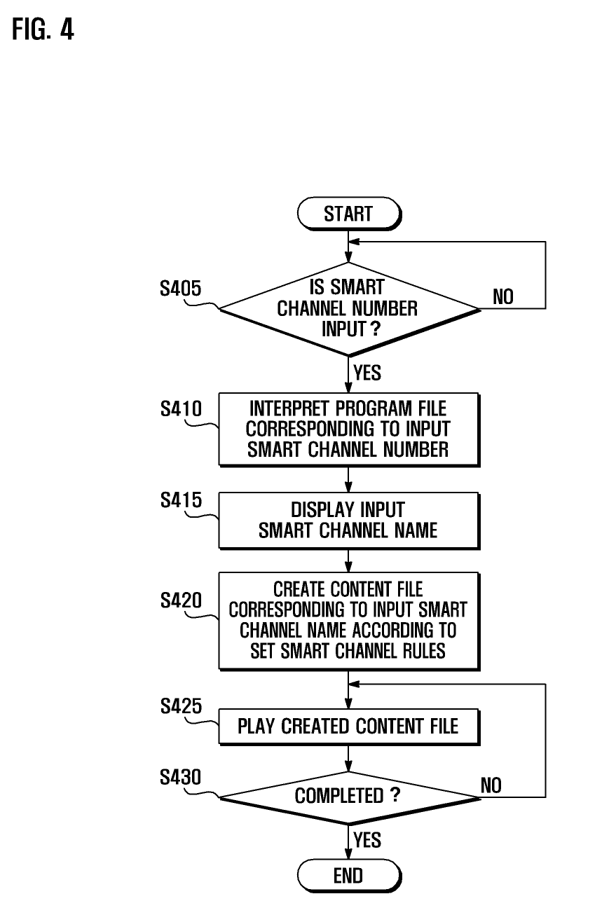

Referring to Table 1 and FIGS. 3A to 3C, the smart channel composer 156 of the control unit 140 determines whether the portable terminal is in a smart channel setting mode in step S302. In step S302, a template received from a specified server of a network may be used. However, a smart channel set using a template directly set by the user is illustrated in FIGS. 3A to 3C. Accordingly, the smart channel composer 156 of the control unit 140 selects a dynamic template. Upon selection of the dynamic template, the smart channel composer 156 of the control unit 140 sets items associated with the smart channel. In other words, the smart channel composer 156 selects an interaction mode in step S304 and selects a view mode according to the user's input under the control of the control unit 140 in step S306. In this case, the selection of the interaction mode may denote a selection of the corresponding mode from a list of functions in the portable terminal or a direct input from the user after the functions of the portable terminal have been searched for. In order to input a smart channel number and a smart channel name for the selected view mode, the smart channel composer 156 selects a user input in step S308, and inputs a channel number and a channel name according to the user's input in step S310. The smart channel composer 156 selects ‘Auto’ indicating automatic execution of a function in step S312, selects ‘Data’ including messages indicating functions that are to be set for the smart channel in step S314, and inputs all received messages in steps S316 to S320. If necessary during driving of the smart channel, other functions may be set to be performed. In this case, in order to allow a Short Message Service (SMS) transmission, the smart channel composer 156 selects ‘SMS’ as a sharing interaction in step S322. When a demand for operation for the smart channel No. 2 is received from the user by a program language as illustrated in Table 1 written according to the setting of FIGS. 3A to 3C, all received messages are displayed on the display unit 170. Such driving of a smart channel will be described in more detail with reference to FIG. 4.

FIG. 4 is a flowchart illustrating a procedure of driving a smart channel set according to an exemplary embodiment of the present invention.

Referring to FIG. 4, the smart channel manager 152 of the control unit 140 determines if a smart channel number for driving the smart channel is input in step S405. Such driving of the smart channel may be performed in a preset manner. For example, in order to drive a smart channel No. 1, a number key ‘1’ may be pressed together with a specific key or the number key ‘1’ may be pressed and held for a preset time period. Further, when a preset key is input, a list of set smart channels may be displayed and a smart channel chosen from the displayed list. In the illustrated example, because the smart channel was set to number ‘1’ using the exemplary method illustrated in FIG. 2, when ‘1’ is chosen from the displayed list, the smart channel No. 1 is driven. Accordingly, the smart channel interpreter 154 interprets a program file corresponding to the input smart channel number No. 1 under the control of the control unit 140 in step S410. Upon interpretation of the program file, a smart channel driver 158 displays the input smart channel name on the display unit 170 according to the interpreted program file under the control of the control unit 140 in step S415. The smart channel name is displayed on the display unit 170 to provide information about the smart channel to be executed to the user. The smart channel name may be set to be displayed only in the case of the user's demand or may not be set to be displayed.

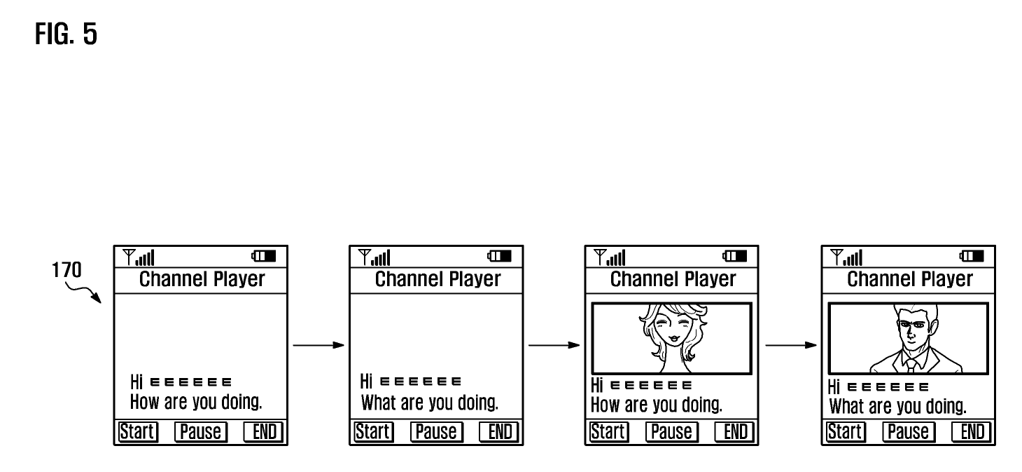

The smart channel driver 158 creates content corresponding to the input smart channel number according to set smart channel rules under the control of the control unit 140 in step S420. For example, when a rule of ‘Show only messages received from a specific sender’ is set using the exemplary procedure illustrated in FIG. 2, the smart channel driver 158 may create a content file using the messages received from the specific sender or may filter the messages received from the specific sender to show the messages under the control of the control unit 140. On the other hand, when a rule of ‘show only messages received from senders except the specific sender’ is set, the smart channel driver 158 may create a content file using only messages received from senders except the specific sender or filter the messages received from the specific sender to show the messages under the control of the control unit 140. In this case, each of the received messages may be content, and a plurality of contents may create a content file or only specific contents may be filtered. In an exemplary implementation, creation of content enables a plurality of contents to be continuously played. For example, as described earlier, a plurality of contents may be created in advance as a single content file. Otherwise, only necessary contents are filtered so as to be played according to specific rules during play of the contents. The smart channel driver 158 plays the content file under the control of the control unit 140 in step S425. In this case, when rules related to play of the contents, such as a drive time, are set, the content file is played according to the set rules. The smart channel manager 152 of the control unit 140 determines if an input that instructs completion of the play is received from the user in step S430. If there is an input instructing completion of the play, the smart channel manager 152 terminates driving of the smart channel or otherwise, the control unit 140 returns to step 425 and continues to play the content file. An example of playing the content file is illustrated in FIG. 5.

FIG. 5 is a sequence diagram illustrating a driving procedure of a smart channel according to an exemplary embodiment of the present invention.

Assuming that four messages as illustrated in FIG. 5 are selected according to set smart channel rules, the smart channel driver 158 creates a content file using the four messages or continuously displays filtered contents on the display unit 170 as illustrated in FIG. 5, under the control of the control unit 140. By doing so, a function customized by the user according to convenience or taste of the user may be performed so that the user may continuously receive desired contents.

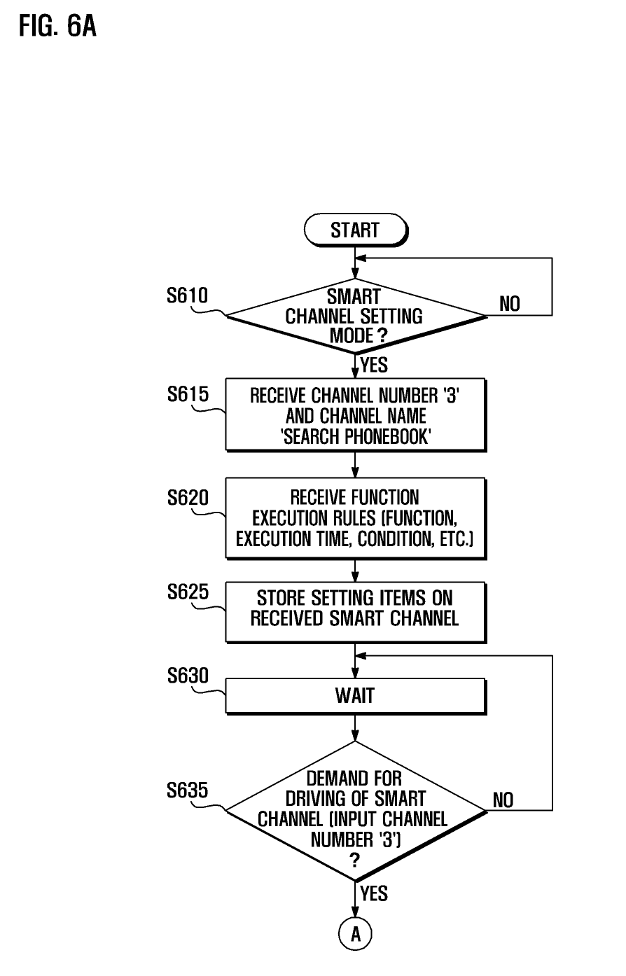

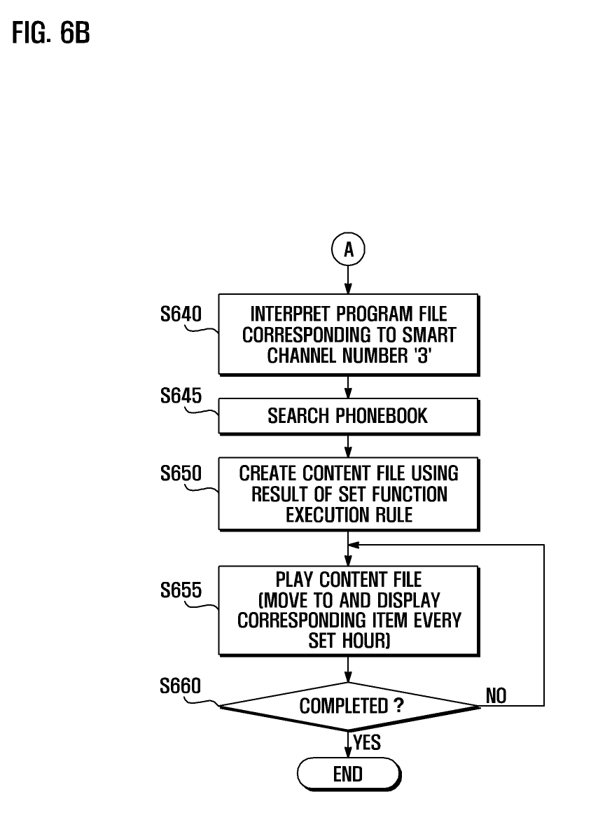

As another exemplary embodiment of creating content, an example of setting a function associated with a phonebook using a smart channel will be described in more detail with reference to FIGS. 6A and 6B.

FIGS. 6A and 6B are flowcharts illustrating a procedure of setting and driving a smart channel according to an exemplary embodiment of the present invention.

Referring to FIGS. 6A and 6B, the smart channel composer 156 of the control unit 140 of FIG. 1 determines whether a portable terminal is in a smart channel setting mode in step S610. When the portable terminal is in the smart channel setting mode, the smart channel composer 156 of the control unit 140 receives a channel number and a channel name that are input from the user in step S615. In the illustrated example, the channel number is set to ‘3’ and the channel name is set to ‘Search phonebook’. In step S620, the smart channel composer 156 of the control unit 140 receives rules for performing functions associated with the smart channel No. 3 that are input from the user. In the illustrated example, ‘Search’, in particular, ‘search phonebook’ is input as the action, a scroll to a next item every 0.5 seconds, is input as an execution time, and a rule of ‘Kim’, is input as an input data condition. The smart channel composer 156 stores set items associated with the received smart channel under the control of the control unit 140 in step S625. The smart channel composer 156 waits until an input for driving of a smart channel is received in step S630. In this case, the stored set items associated the smart channel may be created with XML as illustrated in Table 1.

The smart channel manager 152 of the control unit 140 determines if a demand is made for driving of a smart channel in step S635. Such demand for driving of a smart channel may be determined through an input from the user in a preset manner so as to drive the smart channel, as described above with reference to FIG. 4. Assuming that there is a demand for driving of the smart channel No. 3, the smart channel interpreter 154 of the control unit 140 interprets a program file corresponding to the smart channel No. 3 in step S640. The smart channel driver 158 of the control unit 140 searches a phonebook that reflects an action of the smart channel No. 3 according to the action execution rules in step S645. The smart channel driver 158 of the control unit 140 creates a content file using the searched result according to set function execution rules in step S650. The smart channel driver 158 of the control unit 140 drives, namely, plays the created content file in step S655. In other words, the smart channel driver 158 searches for names with ‘Kim’ as a condition from the phonebook, and displays the uppermost name from a list of searched names on the display unit 170 for 0.5 seconds, and displays the next name after a lapse of 0.5 seconds. In this case, the information associated the name may be displayed together with the name. The smart channel driver 158 determines if it receives a completion instruction from the user in step S660. Upon input for an instruction of completion, driving of the smart channel is terminated. In the case of there not being a completion instructing input, the control unit 140 returns to step S655 to play the content file.

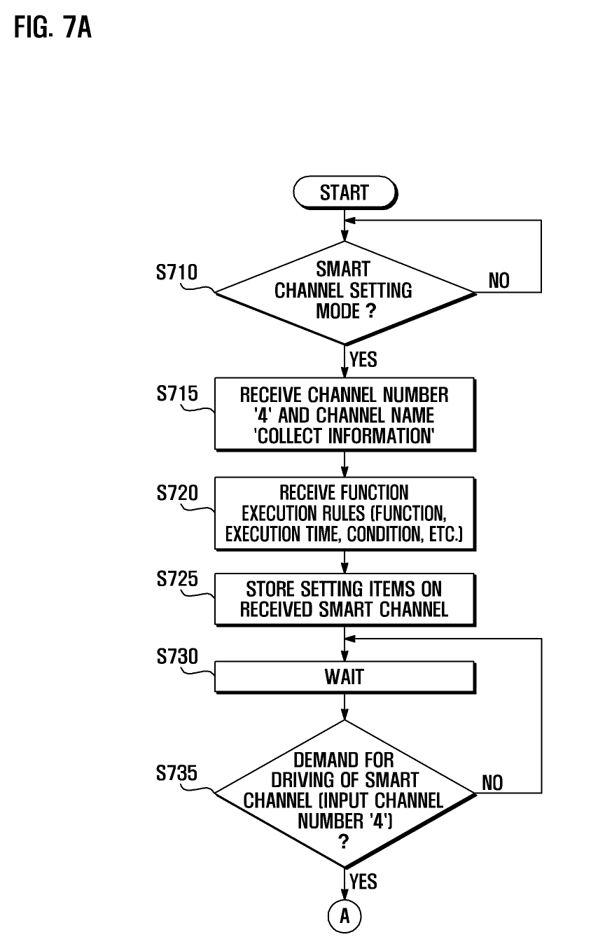

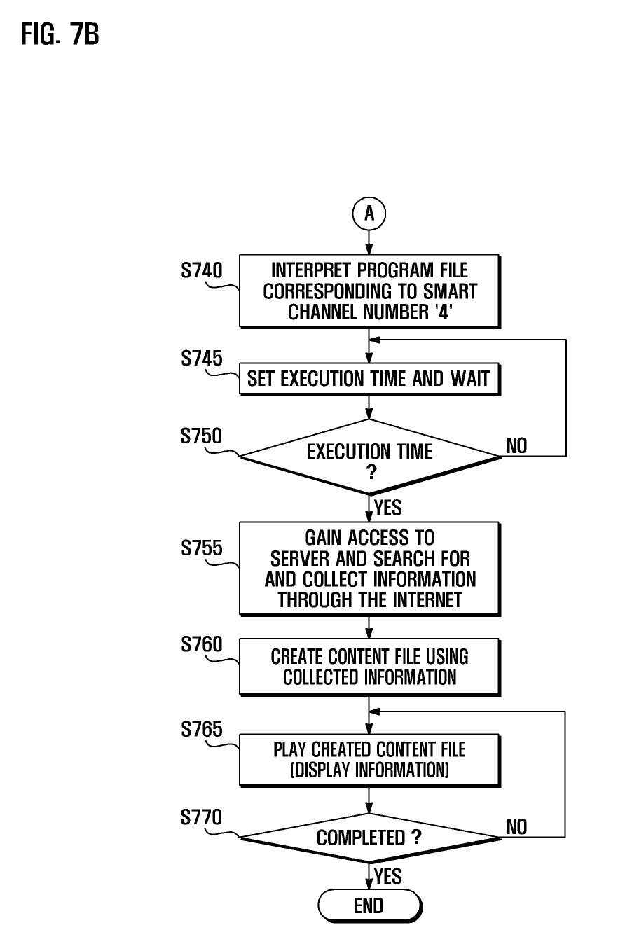

As another exemplary embodiment of creating content, an example of setting a function of gaining access to a web server through the Internet and collecting information using a smart channel will be described with reference to FIGS. 7A and 7B.

FIGS. 7A and 7B are flowcharts illustrating a procedure of setting and driving a smart channel according to an exemplary embodiment of the present invention.

Referring to FIGS. 7A and 7B, the smart channel composer 156 of the control unit 140 in FIG. 1 determines whether a portable terminal is in a smart channel setting mode in step S710. When the portable terminal is in the smart channel setting mode, the smart channel composer 156 receives a channel number and a channel name that are input from the user in step S715. In this case, it is assumed that the channel number is ‘4’ and the channel name is ‘Collect information’. The smart channel composer 156 receives rules for performing functions associated with a smart channel that are input from the user in step S720. In the illustrated example, it is assumed that ‘collect’, in particular, ‘Collect information through access to a specific web server’ is input as the action, 7 o'clock every morning, is input as an execution time, and a rule such as a specific keyword is input as an input data condition. The smart channel composer 156 stores set items associated with the received smart channel under the control of the control unit 140 in step S725. The smart channel composer 156 waits until an input for smart channel driving is received in step S730. In this case, the stored set items associated the smart channel may be created with XML as illustrated in the table 1.

A smart channel manager 152 of the control unit 140 determines if a demand is made for driving of the smart channel in step S735. Such demand for driving of the smart channel may be determined through a smart channel number input from the user in a preset manner so as to drive the smart channel, as described above with reference to FIG. 4. Assuming that there is a request for driving the smart channel No. 4, a smart channel interpreter 154 of the control unit 140 interprets a program file corresponding to the smart channel No. 4 in step S740. The smart channel manager 152 of the control unit 140 drives a timer to set an execution time of the smart channel to 7 O'clock every morning, and waits in step S745. The smart channel manager 152 determines whether the execution time is reached in step S750. When the execution time is reached, the control unit 140 goes to step S755, and otherwise, returns to step S745 and waits.

A smart channel driver 158 gains access to a specified server, for example an Internet site, and searches for and collects desired information demanded by the user in step S755. The smart channel driver 158 may create a content file using the collected information or may show the collected information in step S760. The smart channel driver 158 plays the created content file in step S765. For example, the collected information may be continuously displayed on the display unit 170. Then, when the play time of the content file is set in the action execution rules, after the smart channel driver 158 stores the created content file in the memory unit 180, when the set time is reached, it may play the content file. The smart channel driver 158 may transmit collected information associated with the e-mail function or SMS function to a specified place. The smart channel driver 158 determines if it receives an input for instructing of completion from the user in step S770. In the case of there being an input for instructing of completion, the driving of a smart channel is terminated. In the case of there not being an input for instructing of completion, the control unit 140 returns to the step S765 and continuously plays the content file. By doing so, a plurality of contents may be continuously played according to the convenience of the user with no additional input of the user as in a broadcasting channel.

Certain aspects of the present invention can also be embodied as computer readable code on a computer readable recording medium. A computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion. Also, functional programs, code, and code segments for accomplishing the present invention can be easily construed by programmers skilled in the art to which the present invention pertains.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A method for creating content for playing a plurality of user customized contents in a portable terminal, the method comprising:
receiving rules in a content setting mode;
creating one or more contents according to the received rules; and
continuously playing the one or more contents when an input for instructing play of created content is made.

2. The method of claim 1, wherein the one or more contents are contained in a single file.

3. The method of claim 1, wherein the creating of the one or more contents comprises creating the one or more contents using a program language written and changeable according to the received rules.

4. The method of claim 3, wherein the continuously playing of the one or more contents comprises interpreting the written program language.

5. The method of claim 4, wherein the program language comprises at least one of an eXtensible Markup Language (XML) and a Synchronized Multimedia Integration Language (SMIL).

6. The method of claim 1, wherein the one or more contents comprise at least one of a text message and information containing names in a phonebook.

7. The method of claim 3, wherein the one or more contents comprise information obtained by searching for and collecting information desired by a user from an external server through the Internet.

8. The method of claim 3, wherein the input for instructing play of the created content is made only once by a user.

9. The method of claim 1, further comprising receiving at least one of a smart channel number and a smart channel name for associating with the received rules, wherein the continuously playing of the one or more contents is executed by selecting the at least one of the smart channel number and the smart channel name.

10. The method of claim 9, wherein the selecting of the at least one of the smart channel number and the smart channel name comprises inputting at least one of a number on a key input unit for a preset time, a sequence of numbers on the key input unit, a touch command on a touch screen, a selection from a displayed list, and a voice command.

11. An apparatus for creating content for playing a plurality of user customized contents in a portable terminal, the apparatus comprising:
an input unit for receiving an input for setting or playing one or more contents; and
a control unit for creating the one or more contents according to the input received by the input unit, and for controlling the continuous play of the one or more contents when an instruction for play of created one or more contents is provided.

12. The apparatus of claim 11, wherein the control unit comprises:
a composer for creating a program language based on rules input from the user in a content setting mode; and
a driver for continuously playing the one or more contents when the instruction for play of the one or more contents is provided.

13. The apparatus of claim 12, wherein the driver comprises an interpreter for interpreting the created program language.

14. The apparatus of claim 13, wherein the created program language corresponds to a choice of language input from the user.

15. The apparatus of claim 14, wherein the program language comprises at least one of an eXtensible Markup Language (XML) and a Synchronized Multimedia Integration Language (SMIL).

16. The apparatus of claim 11, wherein the one or more contents comprise at least one of text messages and information containing names in a phonebook.

17. The apparatus of claim 11, wherein the one or more contents comprise information obtained by searching for and collecting information desired by the user from an external server through the Internet.

18. The apparatus of claim 11, wherein an input for instructing play of created content is made only once by the user.

19. The apparatus of claim 11, wherein the one or more contents are contained in a single file.
